(19) United States
(12) Patent Application Publication
(10) Pub. No.: US 2012/0120467 A1
(43) Pub. Date: May 17, 2012

(54) HYBRID LIGHT GUIDE WITH FACETED AND HOLOGRAPHIC LIGHT TURNING FEATURES

(75) Inventors: Russell Wayne Gruhlke, Milpitas, CA (US); Kebin Li, Fremont, CA (US)

(73) Assignee: QUALCOMM MEMS Technologies, Inc., San Diego, CA (US)

(21) Appl. No.: 12/948,572

(22) Filed: Nov. 17, 2010

(51) Int. Cl. G02B 5/32; B23P 11/00; F21V 8/00

(52) U.S. Cl. 359/15; 362/608; 29/428

(57) ABSTRACT

The present disclosure provides systems, methods and apparatus to illuminate displays. In one aspect, an illumination device with a light guide can include both faceted and holographic light turning features. The holographic light turning features can be provided between the facets. The facets can eject light out of the light guide. The holographic light turning features also can eject light out of the light guide, or can collimate the light so that it propagates more nearly parallel to the major surfaces of the light guide, or both eject and collimate light. The ejected light can be used to illuminate a display.

### TECHNICAL FIELD

The present disclosure relates to methods and apparatus for illuminating a display and, more particularly, to illumination devices having faceted and holographic light turning features.

### DESCRIPTION OF THE RELATED TECHNOLOGY

Electromechanical systems include devices having electrical and mechanical elements, actuators, transducers, sensors, optical components (e.g., minors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Reflected ambient light is used to form images in some reflective display devices, such as those using pixels formed by interferometric modulators. The perceived brightness of these displays depends upon the amount of light that is reflected towards a viewer. In low ambient light conditions, light from an artificial light source is used to illuminate the reflective pixels, which then reflect the light towards a viewer to generate an image. New illumination devices are continually being developed to meet the needs of display devices, including displays with pixels that reflective light and displays that transmit light through pixels.

### SUMMARY

The systems, methods and devices of the disclosure each have several innovative aspects, no single one of which is solely responsible for the desirable attributes disclosed herein.

One innovative aspect of the subject matter described in this disclosure can be implemented in an illumination apparatus. The illumination apparatus includes a light source, a light guide, and a hologram. The light guide includes a plurality of spaced-apart facets configured to eject light, propagating from the light source internally through the light guide, out of the light guide. The hologram includes a plurality of holographic light turning features configured to turn light propagating internally through the light guide. The holographic light turning features are disposed in areas between the spaced apart facets. At least some of the holographic light turning features can be configured to turn light out of the light guide and towards the display elements. At least some of the holographic light turning features can be configured to turn light to provide a lower angle of reflectance of the light relative to an angle of incidence of the light on the holographic film. The hologram can be pixilated. A first plurality of the hologram pixels can be configured to eject light out of the light guide body, and a second plurality of the hologram pixels can be configured to collimate light such that an angle of reflectance of the light is less than an angle of incidence of the light on the holographic film.

Another innovative aspect of the subject matter described in this disclosure can be implemented in a display device. The display device includes an image formation means for reflecting incident light towards a display; a light generating means for generating light; a first light turning means for reflecting light from the light generating means towards the image formation means; and a second light turning means for diffracting light from the light generating means towards the image formation means.

Yet another innovative aspect of the subject matter described in this disclosure can be implemented in a method for manufacturing a display device. The method includes providing a light guide panel having a plurality of facets formed in a surface of the panel. A holographic film is provided on the surface of the light guide panel. The holographic film includes a hologram configured to turn light incident on the film.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3A shows an example of a diagram illustrating movable reflective layer position versus applied voltage for the interferometric modulator of FIG. 1.

FIG. 3B shows an example of a table illustrating various states of an interferometric modulator when various common and segment voltages are applied.

FIG. 4A shows an example of a diagram illustrating a frame of display data in the 3×3 interferometric modulator display of FIG. 2.

FIG. 4B shows an example of a timing diagram for common and segment signals that may be used to write the frame of display data illustrated in FIG. 4A.

FIG. 5A shows an example of a partial cross-section of the interferometric modulator display of FIG. 1.

FIGS. 5B-5E show examples of cross-sections of varying implementations of interferometric modulators.

FIG. 6 shows an example of a flow diagram illustrating a manufacturing process for an interferometric modulator.

FIGS. 7A-7E show examples of cross-sectional schematic illustrations of various stages in a method of making an interferometric modulator.

FIGS. 8-10B are examples of partial cross sections of a display system.

FIG. 11 is an example of a top-down plan view of a hologram portion of a display system.

FIG. 12 is an example of a method for manufacturing a display system.

FIGS. 13A and 13B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

Illumination devices may be used to illuminate displays. In some implementations, an illumination device light guide can include both faceted and holographic light turning features. The light turning features turn light that has been injected into the light guide from a light source. In some implementations, both the faceted and the holographic light turning features are configured to eject light out of the light guide, towards the display elements of a display. Alternatively, or in addition to ejecting light out of the light guide, the holographic light turning features can “collimate” the light, so that diffracted light is more nearly parallel to the surface on which the holographic light turning feature is disposed. Stated another way, the angle of that diffracted light propagating away from the holographic film containing the holographic light turning features (referred to herein as the angle of reflectance) is less than the angle of incidence of that light on the holographic film. This collimation can help improve the uniformity of light across the light guide, by facilitating the propagation of light across the light guide.

Particular implementations of the subject matter described in this disclosure can be implemented to realize one or more of the following potential advantages. For example, the holographic light turning features may be positioned at locations between the facets, thereby providing a relatively high density of light turning features and improving the efficiency of light extraction out of the light guide and/or improving the brightness uniformity of the illumination device. The light guide can also be applied in a high efficiency illumination device for illuminating a display, such as a reflective display having interferometric modulators or a transmissive display.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

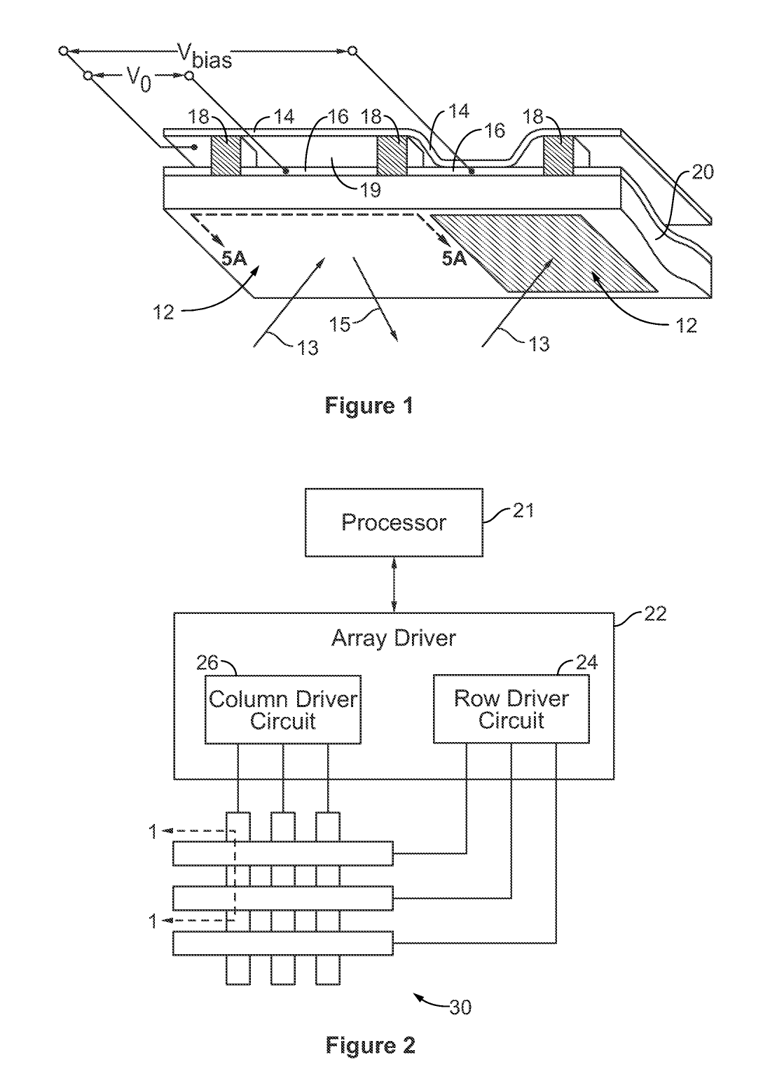

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

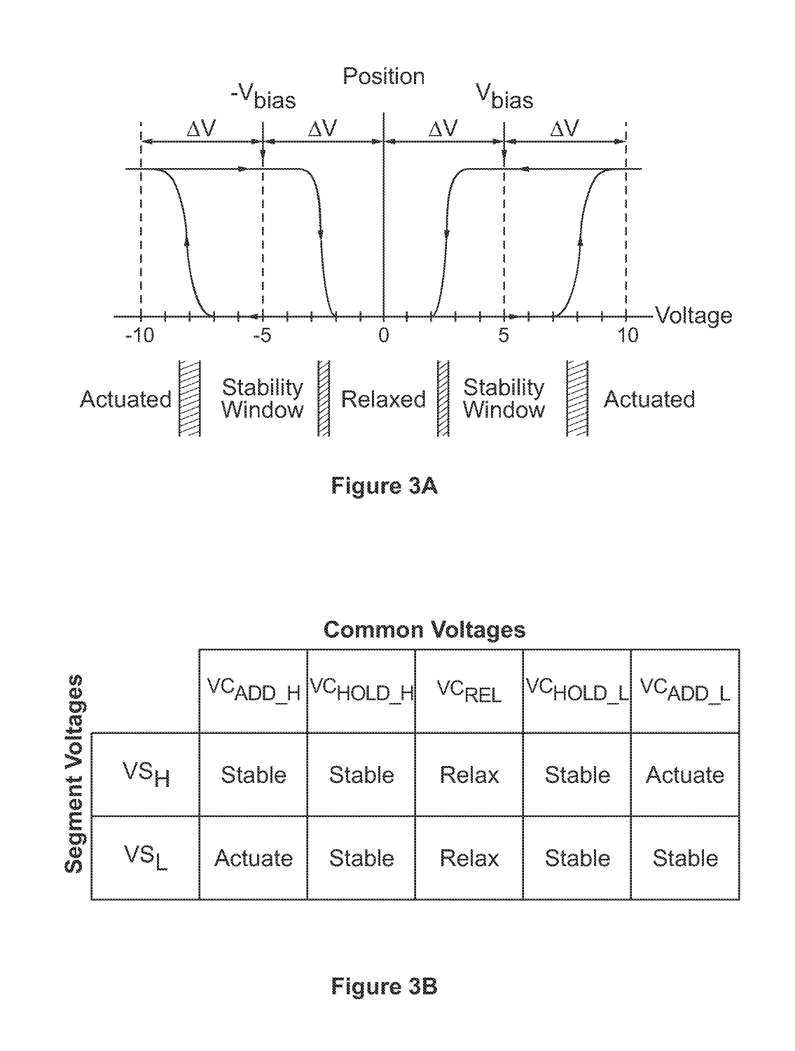

FIG. 3A shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3A. An interferometric modulator may require, for example, about a 10-volt potential difference to cause the movable reflective layer, or minor, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3A, exists where there is a window of applied voltage within which the device is stable in either the relaxed or actuated state. This is referred to herein as the “hysteresis window” or “stability window.” For a display array 30 having the hysteresis characteristics of FIG. 3A, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 3B shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

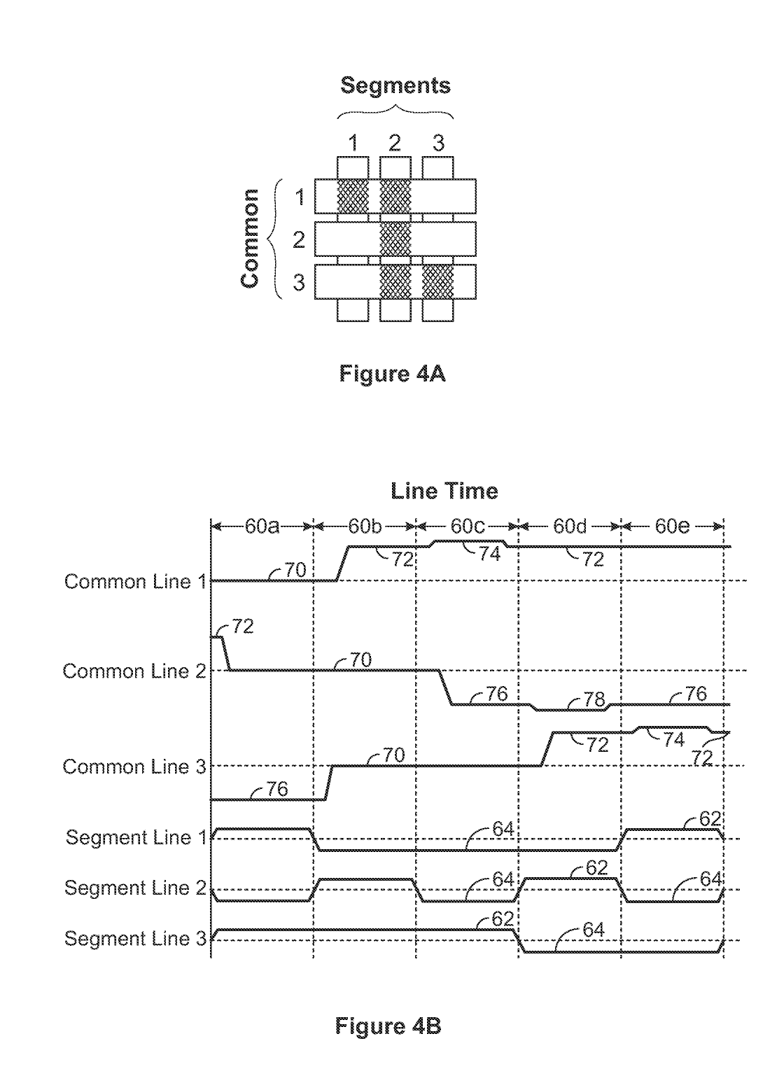

As illustrated in FIG. 3B (as well as in the timing diagram shown in FIG. 4B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3A, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 4A shows an example of a diagram illustrating a frame of display data in the 3×3 interferometric modulator display of FIG. 2. FIG. 4B shows an example of a timing diagram for common and segment signals that may be used to write the frame of display data illustrated in FIG. 4A. The signals can be applied to the, e.g., 3×3 array of FIG. 2, which will ultimately result in the line time 60e display arrangement illustrated in FIG. 4A. The actuated modulators in FIG. 4A are in a dark-state, i.e., where a substantial portion of the reflected light is outside of the visible spectrum so as to result in a dark appearance to, e.g., a viewer. Prior to writing the frame illustrated in FIG. 4A, the pixels can be in any state, but the write procedure illustrated in the timing diagram of FIG. 4B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 3B, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 4A, and will remain in that state as long as the hold voltages are applied along the common lines, regardless of variations in the segment voltage which may occur when modulators along other common lines (not shown) are being addressed.

In the timing diagram of FIG. 4B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 4B. In some other implementations, voltages applied along common lines or segment lines may vary to account for variations in the actuation and release voltages of different modulators, such as modulators of different colors.

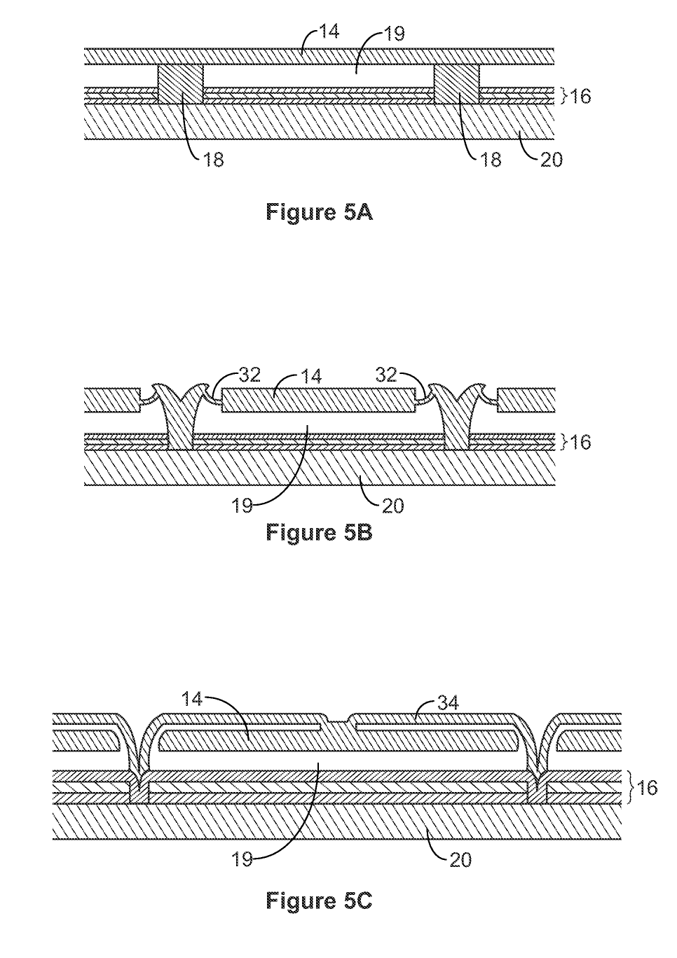

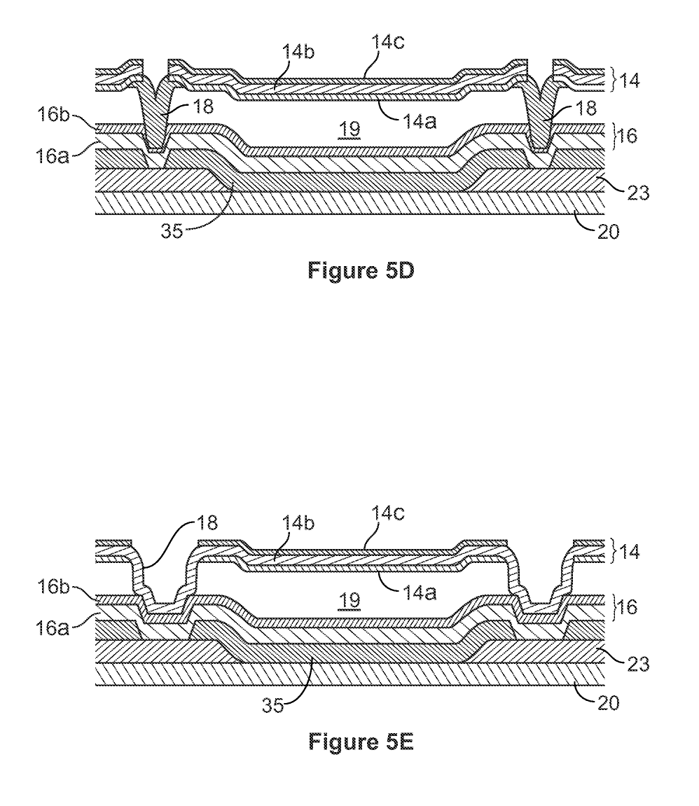

The details of the structure of interferometric modulators that operate in accordance with the principles set forth above may vary widely. For example, FIGS. 5A-5E show examples of cross-sections of varying implementations of interferometric modulators, including the movable reflective layer 14 and its supporting structures. FIG. 5A shows an example of a partial cross-section of the interferometric modulator display of FIG. 1, where a strip of metal material, i.e., the movable reflective layer 14 is deposited on supports 18 extending orthogonally from the substrate 20. In FIG. 5B, the movable reflective layer 14 of each IMOD is generally square or rectangular in shape and attached to supports at or near the corners, on tethers 32. In FIG. 5C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 5C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 5D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 5D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 5E shows another example of an IMOD, where the movable reflective layer 14 is self supporting. In contrast with FIG. 5D, the implementation of FIG. 5E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 5E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 5A-5E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 5C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 5A-5E can simplify processing, such as, e.g., patterning.

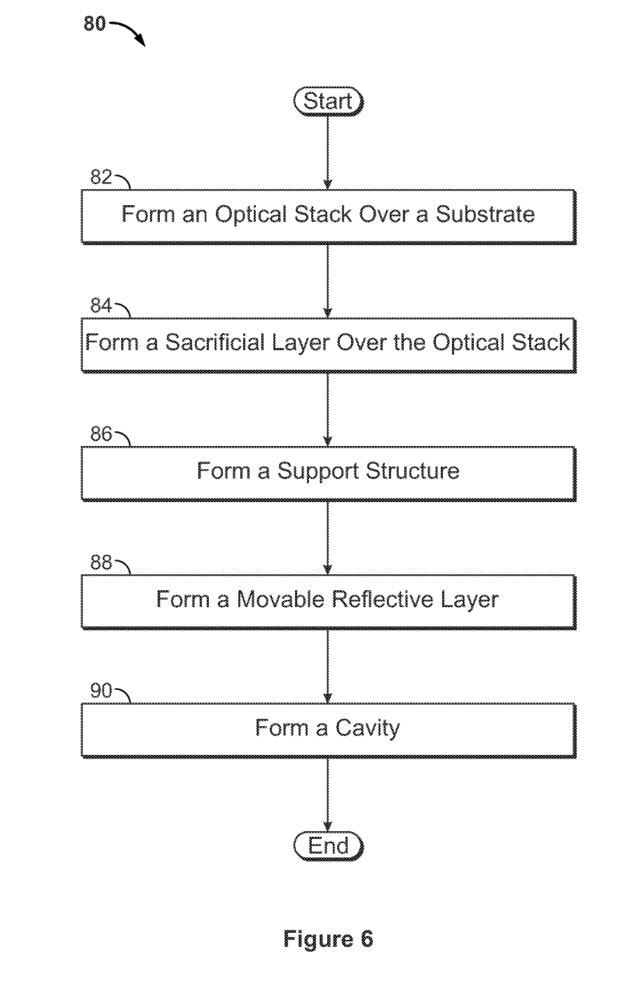

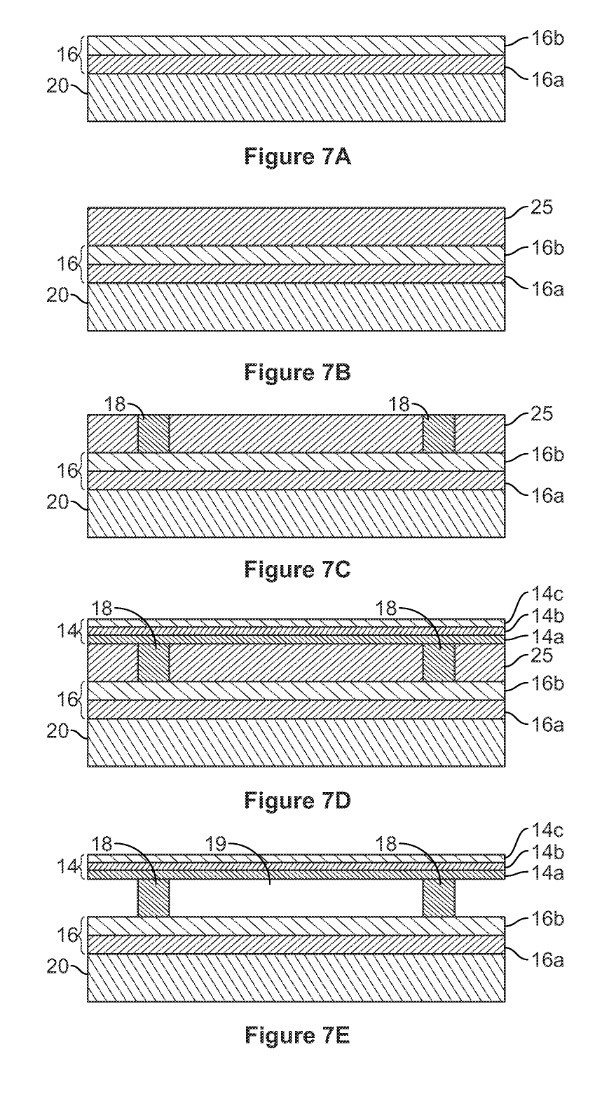

FIG. 6 shows an example of a flow diagram illustrating a manufacturing process 80 for an interferometric modulator, and FIGS. 7A-7E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 5, in addition to other blocks not shown in FIG. 6. With reference to FIGS. 1, 5 and 6, the process 80 begins at block 82 with the formation of the optical stack 16 over the substrate 20. FIG. 7A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 7A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 7B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 7E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 5 and 7C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 5A. Alternatively, as depicted in FIG. 7C, the aperture formed in the sacrificial layer 25 can extend through the sacrificial layer 25, but not through the optical stack 16. For example, FIG. 7E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 7C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 5 and 7D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 7D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 5 and 7E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Displays such as interferometric modulator displays use reflected light to produce an image. In a dark or low-light environment, e.g., some indoor or nighttime environments, there may be insufficient ambient light to generate a useful image. Front lights may be used in such environments to augment or substitute for ambient light. The front light receives light from a light source and redirects it towards the display elements of the display. The light is reflected back past the front light and towards, e.g., the viewer to produce a viewable image.

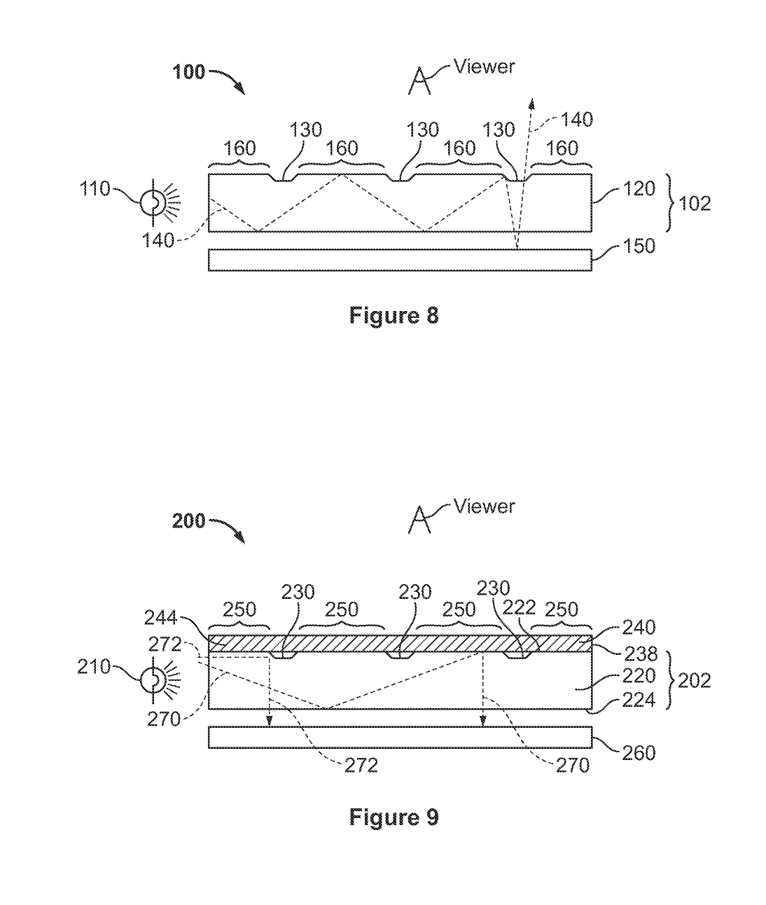

FIG. 8 is an example of a partial cross section of a display system 100 that includes a front light 102. A light source 110 injects light into the left side (for illustration purposes) of a light guide 120. The light propagates from the left side of the light guide 120 towards the right side. The light may be reflected across the light guide 120 by total internal reflection and may be ejected (also referred to as being “turned”) out of the light guide 120 by reflection off a facet 130. For example, a light ray 140 is injected into the light guide 120, where it may impinge on boundaries of the light guide 120 so that it propagates through the light guide 120 by total internal reflection. Upon impinging on one of the facets 130, the light ray 140 may be reflected towards display elements of a display 150 provided behind the light guide 120. The display elements can include reflective or transflective technology, one example being interferometric modulators.

In addition to reflecting light towards display elements of the display 150, the facets 130 can undesirably alter the exit angle for light that was reflected from the display elements of the display 150. The exit angle for light that was reflected from the display 150 (and is on its way towards the viewer) may be altered if that light strikes a facet 130 on its way out of the display 150. Rather than exiting towards the viewer, as does light with no intervening facet 130, light that strikes a facet 130 may have an altered exit angle, thus degrading image quality. To minimize image degradation, the number of facets 130 can be limited and spaced apart.

In some implementations, limiting the number of and spacing apart the facets 130 can limit the amount of light that may be turned (or extracted) out of the light guide 120 and towards the display 150. The surface area between the facets 130 is effectively an “unused” area 160; that is, it is an area that is not used for extraction or light turning. Depending on the given light source, due to the unused area 160, the amount of light extracted in a given area is not as much as theoretically possible and, thus, the brightness of the display 150 may be less than theoretically possible.

In some implementations, a hybrid light guide structure with both facets and holographic light turning features can be provided. The holographic light turning features may be provided between the facets, to allow the previously “unused” area 160 to be used for light turning. Advantageously, the uniformity of light across the light guide 120 or the light extraction efficiency, or both, may be increased.

FIG. 9 is an exemplary partial cross section of a display system 200. The display system 200 can include an illumination device 202. One or more light sources 210 are provided for injecting light into a light guide 220. The light sources 210 may be various light sources known in the art, such as light emitting diodes or fluorescent bulbs. The light sources 210 may directly interface with the light guide 220 or may inject light into the light guide 220 through intermediate coupling structures. The light guide 220 can be formed of a material that supports the transmission and propagation of light. For example, the light guide 220 may be formed of an optically transparent material.

The light guide 220 can include a plurality of facets 230 having reflective surfaces for light turning. Part or all of the surfaces of the facets 230 may be coated with a reflective film, e.g., a metal film, or light turning may occur by total internal reflection.

A holographic film 238 may be disposed on a major surface 222 of the light guide 220. The facets 230 can be formed in, on or near the surface 222. A hologram 240 can be recorded in the holographic film 238. The hologram 240 may be a surface or a volume hologram. The hologram 240 can include light turning features 244. The features 244 may be distributed across the entirety of the holographic film 238, or may be present only at selected locations, e.g., between the facets 230, to minimize the undesired turning of light traveling through the facets 230. One having ordinary skill in the art will readily appreciate that the holographic light turning features 244 may turn light by diffraction and the facets 230 may turn light by reflection.

The holographic light turning features 244 can allow areas 250 between and away from the facets 230 to be utilized for light turning. The hologram 240 and light turning features 244 can be configured to turn light out of the light guide 220 and towards a display 260. For example, the light source 210 can inject a light ray 270 into the light guide 220 and the light ray 270 may reflect off the boundaries of the light guide 220 until contacting a holographic light turning feature 244, which turns the light ray 270 to eject it out of the light guide 220 towards the display 260. In addition, another light ray 272 may contact one of the facets 230 and be ejected out of the light guide 220 by that facet. The holographic light turning features 244 may augment the facets 230 to increase the amount of light extracted from the light guide 220, thereby increasing the perceived brightness of the display 260 without needing to increase the power of the light source 210.

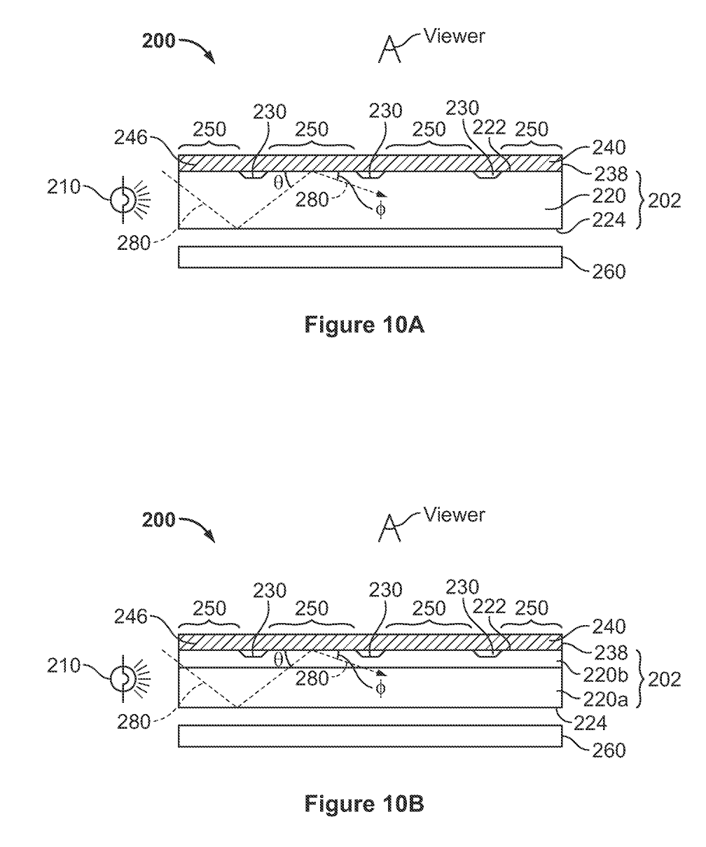

In some implementations, and with reference to FIG. 10A, the hologram 240 can contain collimating holographic light turning features 246 that are configured to collimate light. An example of this collimation is illustrated by light ray 280. The light ray 280 can be injected into the light guide 220 and impinge on the holographic film 238 at an angle of incidence θ. Collimating holographic features 246 in holographic film 238 can turn the light ray 280 so that an angle of reflectance φ of the ray 280 is less than the angle of incidence θ. Thus, the light ray 280 can be configured more parallel to major surfaces 222, 224 of the light guide 220 after diffracting off the holographic film 238 than when the light ray 280 impinged on the holographic film 238. In some implementations, by making the light rays more parallel to the major surfaces 222, 224 of the light guide 220, the probability of the light rays propagating farther across the light guide 220 is increased, thereby increasing the amount of light reaching locations relatively far from the light source 210, which in turn increases the brightness uniformity of the illumination device 202. The collimating holographic features 246 also can be configured such that the degree of collimation is set to have diffracted light strike the facets 230 at angles that are more likely to be extracted by the facets 230, which can help further increase display brightness. The collimating holographic features 246 may be disposed in the areas 250 between and away from the facets 230, thereby allowing those areas to be utilized for light turning.

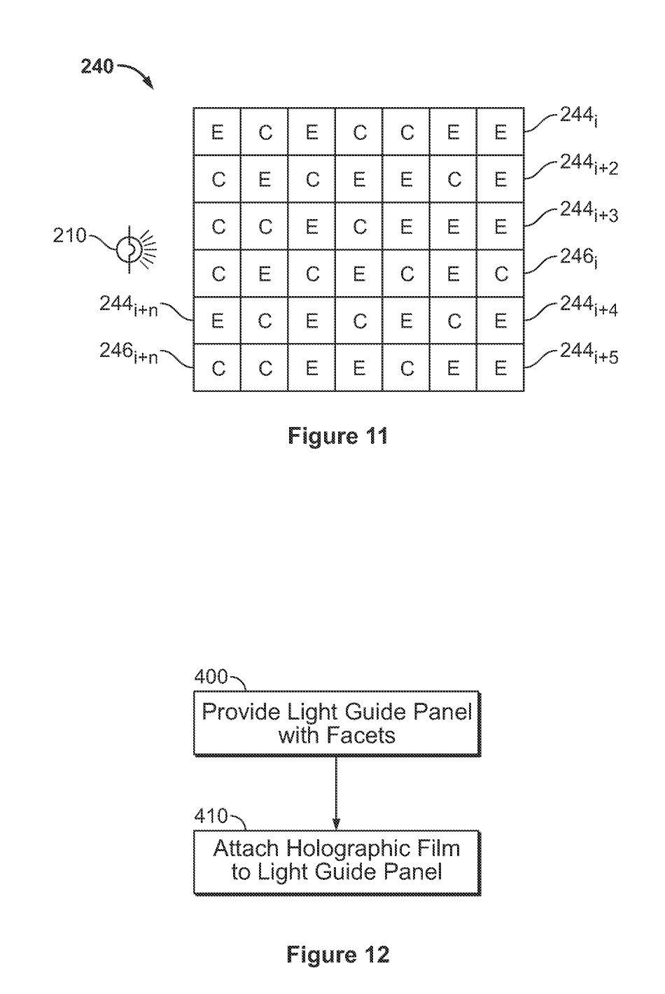

With reference to FIG. 11, the hologram 240 can be pixilated. Two or more sets or pluralities of similar pixels may be provided. FIG. 11 is an exemplary top-down plan view of the hologram 240, with discrete pixels 244ᵢ₊ₙ and 246ᵢ₊ₙ, each containing different types of holographic light turning features. For example, pixels 244ᵢ₊ₙ may be configured to eject light out of the light guide 220, while pixels 246ᵢ₊ₙ may be configured to collimate light. The pixels 244ᵢ₊ₙ configured to eject light out of the light guide 220, are indicated by an “E.” The pixels 246ᵢ₊ₙ configured to collimate light, are indicated by a “C.” Pixilation allows the density and/or properties of the hologram 240 to be varied over the area of the light guide 220 (as shown in FIGS. 8-10). For example, to increase brightness uniformity, the density of the pixels 244ᵢ₊ₙ, having holographic light turning features that eject light, can increase with distance from the light source 210. Because light is extracted as it propagates across the light guide 220, less and less light is present in the light guide 210 as distance from the light source 210 increases. Increasing the density of the pixels 244ᵢ₊ₙ with distance from the light source 210 can increase the efficiency of light extraction with distance from the light source 210, which can compensate for these decreasing levels of light by turning a larger fraction of the available light present in the light guide 220 at the further distances from the light source 210.

In another example, the density of the pixels 246ᵢ₊ₙ for collimation can decrease with distance from the light source 210, since the need to collimate light to increase propagation distance across the light guide 220 decreases with distance from the light source 210. In some implementations, the pixels 246ᵢ₊ₙ for collimation serve to increase the distance that light propagates across the light guide 220 before travelling out of the light guide 220. At farther distances from the light source 210, as the light propagates farther across the light guide 220, the need to propagate the light still farther across the light guide 220 decreases as the light comes to the opposite side of the light guide 220, while it becomes increasingly desirable to extract light out of the light guide 220. Thus, the density of the pixels 246ᵢ₊ₙ for collimation can decrease with distance from the light source 210 and, in some implementations, the density of the pixels 244ᵢ₊ₙ configured to eject light increase with distance from the light source 210.

In addition, within each set of the pixels 244ᵢ₊ₙ and 246ᵢ₊ₙ the properties of individual pixels can vary. For example, individual ones of the pixels 244ᵢ₊ₙ and/or pixels 246ᵢ₊ₙ can be configured to accept and turn light incident on the pixels 244ᵢ₊ₙ and/or pixels 244ᵢ₊ₙ in different ranges of angles. This feature can be implemented to minimize optical artifacts, since a single uniform hologram can have difficulties turning light from a wide range of angles. In some implementations, the pixels 244ᵢ₊ₙ and 246ᵢ₊ₙ effectively define a plurality of hologram regions, with each pixel having a limited range of angles accepted for turning, which can increase the efficiency of the turning and reduce artifacts. In addition, the degree of collimation of the pixels 246ᵢ₊ₙ or the direction that the pixels 244ᵢ₊ₙ are configured to turn light can vary between individual pixels, thereby allowing the illumination properties of the illumination device 202 (as shown in FIGS. 9 and 10) to be varied.

In some implementations, only some of the pixels 244ᵢ₊ₙ and 246ᵢ₊ₙ are configured to turn light. The other pixels may be devoid of holographic light turning features and may be used simply as spacers to separate the other pixels that contain holographic light turning features. In some other implementations, the pixels 244ᵢ₊ₙ, 246ᵢ₊ₙ for turning light may be configured to perform only one of the functions of collimating light or ejecting light out of the light guide.

FIG. 12 is an example of a method for manufacturing a display system. A light guide panel can be provided 400 having a plurality of facets formed in a surface of the panel. A holographic film can subsequently be attached 410 to the surface of the light guide panel. The holographic film includes a hologram configured to turn light incident on the film, as described herein.

Components of the display systems 100, 200 (FIGS. 8-10B) may be formed by various manufacturing methods. For example, the facets 230 may be formed in the light guide 220 by removing material from the light guide 220, or may be formed on a film which is attached to a main body 220a of the light guide 220. FIG. 10B is an example of a partial cross section of a display system having a film 220b in which the facets 230 are formed. The facets 230 may be formed in the film 220b by various methods, including embossing or etching. In some implementations, the film 220b is a part of the light guide 220 and has a refractive index which matches the refractive index of the main body 220a of the light guide 220, so that light propagates by total internal reflection through both the main body 220a and the film 220b. Subsequently, to form the display systems 100, 200, the holographic film 238, having a recorded hologram 240 may be attached to the light guide 220, e.g., using an adhesive. The light guide 220 may then be attached to the display 260, e.g., using an adhesive. Additionally, the facets 230 can be on one or both surfaces of the light guide 220.

The hologram 240 may be formed by two or more beams of laser light directed into and meeting in the holographic film 238. One beam may be normal to the holographic film 238 and the other may impinge on the holographic film 238 from the same direction as light to be turned by the hologram 240. Also, the hologram 240 can be disposed on one or both of the major surfaces 222, 224. Alternatively, the hologram 240 may be on the same side of the light guide 220 as the facets 230, or on different sides of the light guide 220. In some implementations, where the light guide 220 can support the formation of a hologram 240, the light guide 220 and the holographic film 238 may be a single, integral body of holographic material. In addition, other materials may be disposed over the holographic film 238, such as anti-reflective and/or scratch-resistant layers. Also, although the holographic film 238 has been illustrated as the uppermost part of the display device 200 for ease of illustration and discussion, the holographic film 238 can be configured in or on other areas of the display device 200.

The pixels 244ᵢ₊ₙ and 246ᵢ₊ₙ may be formed by separately forming individual sets of pixels. In some implementations, the pixels 244ᵢ₊ₙ may be formed using a mask with openings that allow illumination of selected portions of the holographic film 238 in a first position. The mask may be shifted to other positions, e.g., a second position, to form the pixels 246ᵢ₊ₙ and the holographic film 238 may be exposed to light while the mask is in each of these other positions. Thus, an array of regularly repeating, discrete regions configured with particular light turning characteristics may be formed. Each discrete region can form a pixel of the hologram 238. At each position, the holographic film 238 can be exposed to laser light of a different wavelength and/or direction. The wavelength may correspond to the wavelength of light that the pixel is configured to turn. The laser light can include laser beams oriented substantially normal to the holographic film 238. In addition, a secondary beam is directed into the holographic film 238 at the same direction as light to be turned by the hologram 240. In some implementations, multiple secondary beams may be applied to allow light from a plurality of different directions to be turned by the pixel that is formed.

In some implementations, the illumination device 202 may be applied as a backlight for use with transmissive displays in which light travels through display elements. For example, instead of being situated in front of a display 260 that reflects light back past the light guide 220, as in implementations in which the display 260 has reflective display elements, the light guide 220 and light source 210 may be disposed behind the display 260 in a transmissive display. In this implementation, the light guide 220 and light source 210 are oriented to emit light that propagates forward, the light propagating through the display elements of the display 260 and towards, e.g., a viewer.

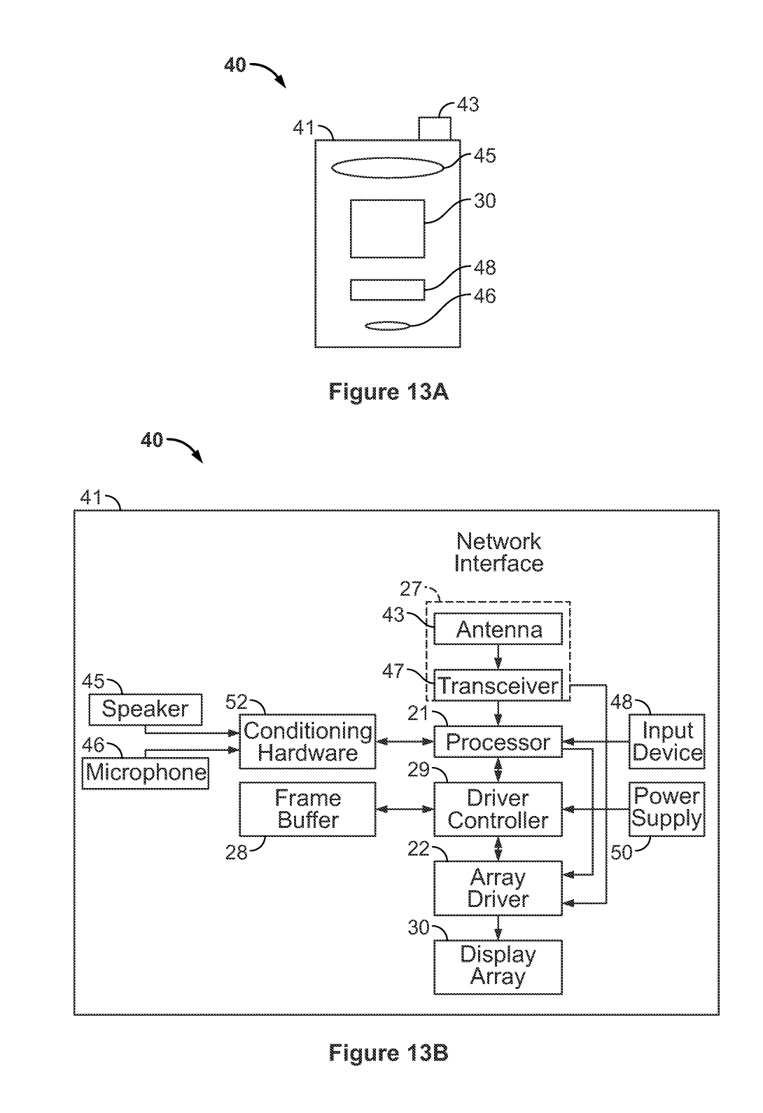

FIGS. 13A and 13B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An illumination apparatus, comprising:
a light source;
a light guide comprising a plurality of spaced-apart facets configured to eject light, propagating from the light source internally through the light guide, out of the light guide; and
a hologram, the hologram comprising a plurality of holographic light turning features configured to turn light propagating internally through the light guide.

2. The apparatus of claim 1, wherein the hologram is on a surface of the light guide.

3. The apparatus of claim 1, wherein the holographic light turning features are disposed in areas between the spaced apart facets.

4. The apparatus of claim 1, wherein the hologram is provided in a holographic film disposed on the light guide.

5. The apparatus of claim 1, further comprising a display comprising a plurality of display elements.

6. The apparatus of claim 5, wherein the display elements comprise interferometric modulators.

7. The apparatus of claim 5, wherein at least some of the holographic light turning features are configured to turn light out of the light guide and towards the display elements.

8. The apparatus of claim 5, wherein at least some of the holographic light turning features are configured to turn light to provide a lower angle of reflectance of the light relative to an angle of incidence of the light on the holographic film.

9. The apparatus of claim 1, wherein the hologram is pixilated.

10. The apparatus of claim 9, wherein a first plurality of hologram pixels are configured to eject light out of the light guide body, and wherein a second plurality of hologram pixels are configured to collimate light such that an angle of reflectance of the light is less than an angle of incidence of the light on the holographic film.

11. The apparatus of claim 10, wherein a first density of the first plurality of hologram pixels increases with distance from the light source and wherein a second density of the second plurality of hologram pixels decreases with distance from the light source.

12. The apparatus of claim 1, wherein the facets comprise a reflective metal coating.

13. The apparatus of claim 1, further comprising:
a display underlying the light guide body;
a processor that is configured to communicate with the display, the processor being configured to process image data; and
a memory device that is configured to communicate with the processor.

14. The apparatus of claim 13, further comprising:
a driver circuit configured to send at least one signal to the display.

15. The apparatus of claim 14, further comprising:
a controller configured to send at least a portion of the image data to the driver circuit.

16. The apparatus of claim 13, further comprising:
an image source module configured to send the image data to the processor.

17. The apparatus of claim 16, wherein the image source module comprises at least one of a receiver, transceiver and transmitter.

18. The apparatus of claim 13, further comprising:
an input device configured to receive input data and to communicate the input data to the processor.

19. A display device, comprising:
an image formation means for reflecting incident light towards a display;
a light generating means for generating light;
a first light turning means for reflecting light from the light generating means towards the image formation means; and
a second light turning means for diffracting light from the light generating means towards the image formation means.

20. The device of claim 19, wherein the first light turning means comprises a plurality of facets in a light guide panel disposed over the first means.

21. The device of claim 20, wherein the second light turning means is a hologram.

22. The device of claim 21, wherein the hologram comprises holographic light turning features interspersed between facets of the plurality of facets.

23. The device of claim 21, wherein the hologram is formed in a holographic film disposed on the light guide panel.

24. The device of claim 21, wherein the hologram is a volume hologram.

25. The device of claim 21, wherein the hologram is pixilated, wherein some pixels of the hologram are configured to turn light towards the image formation means and some other pixels of the hologram are configured to collimate light to provide a lower angle of reflectance of the light relative to an angle of incidence of the light on the holographic film.

26. The device of claim 19, wherein the image formation means is a plurality of interferometric modulators.

27. The device of claim 19, wherein the light generating means is a light emitting diode.

28. A method for manufacturing a display device, comprising:
providing a light guide panel having a plurality of facets formed in a surface of the panel; and
providing a holographic film on the surface of the light guide panel, the holographic film comprising a hologram configured to turn light incident on the film.

29. The method of claim 28, wherein providing the holographic film comprises attaching the holographic film to the surface in which the facets are formed.

30. The method of claim 28, wherein the facets are configured to eject light out of the panel through one of the surfaces of the panel.

31. The method of claim 30, wherein the hologram is configured to eject light out of the one of the surfaces.

32. The method of claim 28, further comprising attaching a display to the light guide panel.

33. The method of claim 32, wherein the display comprises a plurality of interferometric modulators, the interferometric modulators forming pixels of the display.

34. The method of claim 28, wherein providing the holographic film comprises forming the hologram by a process comprising:
forming first and second sets of holographic light turning structures.

35. The method of claim 34, wherein the first set of holographic light turning structures is configured to eject light out of one of the surfaces of the panel.

36. The method of claim 34, wherein the first set of holographic light turning structures is configured to collimate light to provide a lower angle of reflectance of the light relative to an angle of incidence of the light on the holographic film.
